(19) United States
(12) Patent Application Publication
(10) Pub. No.: US 2021/0027264 A1
(43) Pub. Date: Jan. 28, 2021

(54) SYSTEMS AND METHODS FOR ACCEPTING CASH DEPOSITS OR BILLPAYS AT MERCHANT POINT OF TRANSACTION DEVICES

(71) Applicant: JPMORGAN CHASE BANK, N.A., New York, NY (US)

(72) Inventors: Lee L. HOU, Glen Mills, PA (US); Howard SPECTOR, Woolwich, NJ (US); Scott H. OUELLETTE, Kingston, NH (US); Winter P. NG, Lutz, FL (US)

(21) Appl. No.: 16/934,618

(22) Filed: Jul. 21, 2020

Related U.S. Application Data
(60) Provisional application No. 62/877,427, filed on Jul. 23, 2019.

(51) Int. Cl. G06Q 20/10; G06Q 20/18; G06Q 20/38; G06Q 20/42

(52) U.S. Cl. CPC G06Q 20/108; G06Q 20/42; G06Q 20/385; G06Q 20/18

(57) ABSTRACT

A method for accepting cash deposits or billpays at merchant point of transaction devices may include: (1) receiving, from a customer mobile device, a mobile deposit request comprising a deposit account identifier for a deposit or a mobile billpay request including a payee identifier and a billpay amount; (2) generating a code for the mobile deposit request or the mobile billpay request; (3) communicating the code to the customer mobile device; (4) receiving, from a merchant point of transaction device, a deposit request or a billpay request comprising the code and a received amount; (5) identifying, from the code, the deposit account identifier or the billpay payee identifier and billpay amount; and (6) depositing the received deposit amount to a deposit account associated with the deposit account identifier or executing a billpay to payee associated with the payee identifier for the billpay amount.

### RELATED APPLICATIONS

This application claims priority to, and the benefit of, U.S. Provisional Patent Application Ser. No. 62/877,427 filed Jul. 23, 2019, the disclosure of which is hereby incorporated, by reference, in its entirety.

### BACKGROUND OF THE INVENTION

### 1. Field of the Invention

Embodiments are generally related to systems and methods for accepting cash deposits or billpays at merchant point of transaction devices.

### 2. Description of the Related Art

Even though automated teller machines (ATMs) seem to be ubiquitous, there are still locations where a banking customer may not be located near an ATM or a bank's branch office, or it may be inconvenient for the banking customer to travel to an ATM or branch office. Thus, some banking customers may have a difficult time depositing cash into their accounts.

### SUMMARY OF THE INVENTION

Systems and methods for accepting cash deposits or billpays at merchant point of transaction devices are disclosed. According to one embodiment, in an information processing apparatus comprising at least one computer processor, a method for accepting cash deposits at merchant point of transaction devices may include: (1) receiving, from a customer mobile device, a mobile deposit request comprising a deposit account identifier for a deposit; (2) generating a deposit code for the mobile deposit request; (3) communicating the deposit code to the customer mobile device; (4) receiving, from a merchant point of transaction device, a deposit request comprising the deposit code and a received deposit amount; (5) identifying, from the deposit code, the deposit account identifier; and (6) depositing the received deposit amount to a deposit account associated with the deposit account identifier.

In one embodiment, the mobile deposit request may include a submitted deposit amount.

In one embodiment, the method may include sending a notification to the customer mobile device in response to the submitted deposit amount being different from the received deposit amount.

In one embodiment, the deposit code may include a one-time code.

In one embodiment, the deposit code may include a machine-readable code.

In one embodiment, the deposit request may be received over a payment network.

In one embodiment, the method may further include sending a deposit confirmation to the merchant point of transaction device.

In one embodiment, the method may further include sending a deposit confirmation to the customer electronic device.

According to another embodiment, at an information processing apparatus for a financial institution, a method for accepting billpays at merchant point of transaction devices may include: (1) receiving, from a customer mobile device, a mobile billpay request comprising a billpay payee identifier and a submitted billpay amount; (2) generating a billpay code for the mobile billpay request; (3) communicating the billpay code to the customer mobile device; (4) receiving, from a merchant point of transaction device, a billpay request comprising the billpay code and a received billpay amount; (5) identifying, from the billpay code, the billpay payee identifier; and (6) executing a billpay to the billpay payee for the billpay amount.

In one embodiment, the method may further include sending a notification to the customer mobile device in response to the submitted billpay amount being different from the received billpay amount.

In one embodiment, the billpay code may include a one-time code.

In one embodiment, the billpay code may include a machine-readable code.

In one embodiment, the billpay request may be received over a payment network.

In one embodiment, the method may further include sending a billpay confirmation to the merchant point of transaction device.

In one embodiment, the method may further include sending a billpay confirmation to the customer electronic device.

According to another embodiment, at an information processing apparatus for a financial institution, a method for accepting cash deposits at merchant point of transaction devices may include: (1) receiving, from a customer mobile device, a mobile deposit request comprising a deposit account identifier for a deposit or a mobile billpay request comprising a billpay payee identifier and a billpay amount; (2) communicating the deposit account identifier or the billpay payee identifier and the billpay amount and a session identifier for the session with the customer mobile device to a deposit or billpay service; (3) generating a code for the mobile deposit request or the mobile billpay request, wherein the code comprises the session identifier; (4) communicating the code to the customer mobile device; (5) receiving, from a merchant point of transaction device, a deposit or billpay request comprising the code and a received amount; (6) identifying, from the code, the session identifier; (7) identifying the deposit account or billpay payee and billpay amount matching the session identifier; and (8) depositing the received amount to the deposit account or executing a billpay to the billpay payee for the billpay amount.

In one embodiment, the mobile deposit request may include a submitted deposit amount.

In one embodiment, the deposit account identifier or the billpay payee identifier and the billpay amount and the session identifier may be communicated to the deposit or billpay service over a private network.

In one embodiment, the deposit request or the billpay request may be received over a payment network.

In one embodiment, the method may further include sending a deposit confirmation or a billpay confirmation to the customer electronic device.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for accepting cash deposits or billpays at merchant point of transaction devices according to one embodiment;

FIG. 2 illustrates a method for accepting cash deposits or billpays at merchant point of transaction devices according to one embodiment; and

FIG. 3 illustrates a method for accepting cash deposits or billpays at merchant point of transaction devices according to another embodiment.

### DETAILED DESCRIPTION OF PREFERRED EMBODIMENTS

Embodiments are directed to systems and methods for accepting cash deposits or billpays at merchant point of transaction devices. For example, embodiments may enable real-time, or substantially real-time, cash deposits and bill payments at cashier stations from local merchants. The merchants may participate in a payment network provided by the financial institution, such as ChaseNet. The transactions may be verified using, for example, a mobile application, a one-time token or code, etc.

In embodiments, a customer of a financial institution may deposit cash to his/her checking/DDA accounts by handing the cash to a cashier at a local merchant, such as a ChaseNet-supported merchant.

In one embodiment, the customer may have a checking or DDA account with the financial institution and may have a “deposit-enabled” debit card.

In one embodiment, the merchants may be enabled to accept a token (e.g., by scanning a QR code, barcode, SKU) at a merchant POS device.

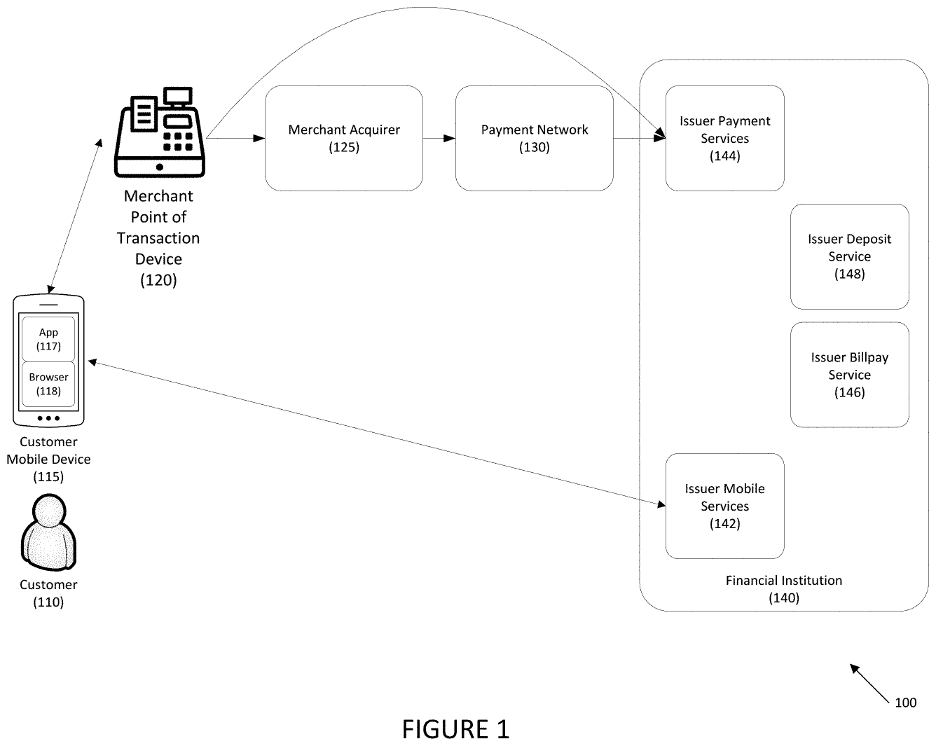

Referring to FIG. 1, a system for accepting cash deposits or billpays at merchant point of transaction devices is disclosed according to one embodiment.

System 100 may include customer 110 using customer mobile device 115. Customer 110 may be customer of financial institution 140. Customer mobile device 115 may be any suitable electronic device, including smart phones, computers (e.g., tablet computers, notebook computers, etc.), smart watches, smart rings, Internet of Things (“IoT”) appliances, etc.

Customer mobile device 115 may execute application or program 117, such as an application or program associated with, or provided by, financial institution 140. In another embodiment, customer mobile device 115 may execute a browser application that may access a website for financial institution 140.

Customer mobile device 115 may communicate with merchant point of transaction device 120, which may be any suitable device capable of interfacing with customer mobile device 115 by near field communication (NFC), by scanning a code presented on customer mobile device 115, etc. In one embodiment, customer mobile device 115 may scan a code from merchant point of transaction device 120, may receive a NFC communication from merchant point of transaction device 120, etc.

Customer mobile device 115 may further communicate with issuer 140 using, for example, issuer mobile services 142. Issuer mobile services 142 may interface with issuer payment services 144, which may provide a machine-readable code, such as a QR code, a NFC code, an alphanumeric code, etc. to customer mobile device 115 for a deposit.

Merchant point of transaction device 120 may be any suitable point of sale device, including point of sale devices, kiosks, mobile electronic devices and computers, etc. In one embodiment, merchant point of transaction device 120 may be associated with a cash receptacle, such as a cash drawer, cash drop, etc.

Merchant point of transaction device 120 may communicate with financial institution 140 via acquirer 125 and payment network 130, which may be any suitable payment network. Examples include ChaseNet, VisaNet, etc. In another embodiment, merchant point of transaction device 120 may communicate with financial institution 140 directly using, for example, a public network, a private network, the Internet, etc. In one embodiment, merchant point of transaction device 120 may communicate with a merchant host (not shown) first, within a store, or at a corporate location, and then communicate with financial institution 140 over a public/private network.

Payment network 130 may communicate with issuer payment services 144. In one embodiment, issuer payment services 144 may receive a cash deposit/billpay request, process the deposit/billpay request, and confirm the deposit/billpay with merchant point of transaction device 120.

Financial institution 140 may further provide deposit service 148, billpay service 146, and any other services as is necessary and/or desired.

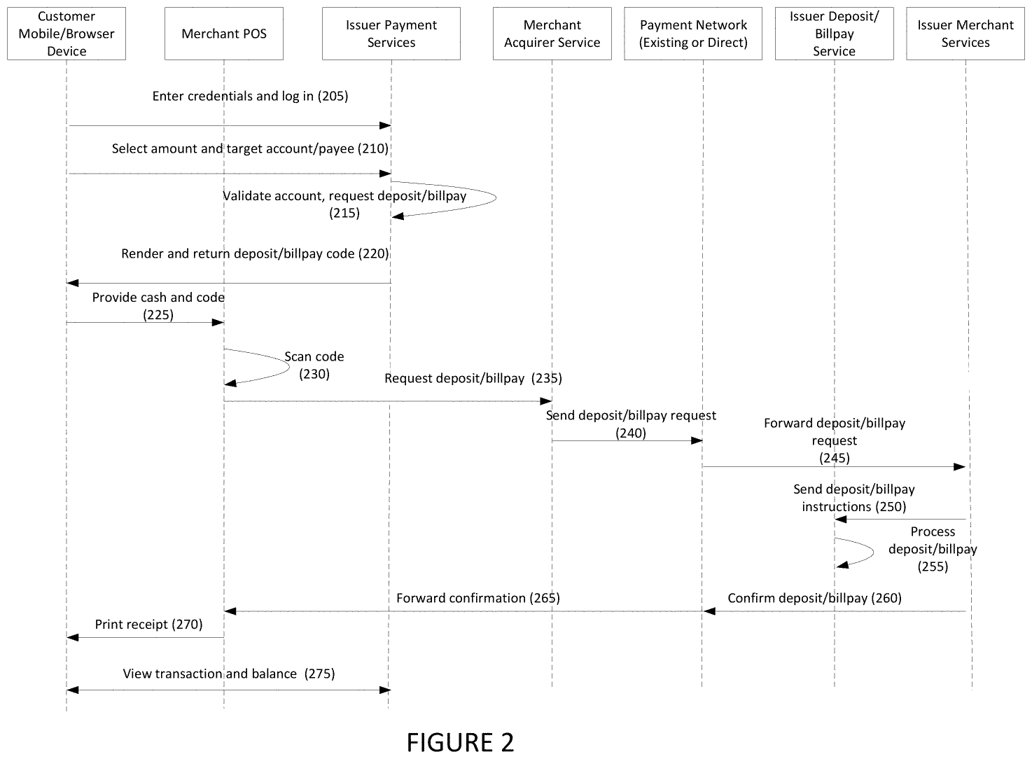

Referring to FIG. 2, a method for accepting cash deposits or billpays at merchant point of transaction devices is provided according to one embodiment. In step 205, a customer may login to a mobile electronic device by entering his or her credentials, and in step 210, the customer may select a deposit/billpay amount and one or more target account (e.g., a DDA, a checking account, etc.), one or more payee, a combination of the two (e.g., deposit $150 to savings, $50 to checking, pay wireless provider $100). The customer may enter the information into a computer application provided by or associated with the financial institution.

In one embodiment, the customer may not identify a deposit amount on the mobile electronic device.

In step 215, the issuer payment services may validate the deposit account(s) and/or payee(s), and in step 220, the issuer payment services may render and return a machine-readable code (e.g., a QR code, a bar code, etc.), a NFC code, a token, an alphanumeric code, etc. to the mobile electronic device. In one embodiment, the code may include deposit/billpay details (e.g., amount, account, payee, etc.), may include a session identifier, etc.

In one embodiment, the code may be a one-time code (e.g., for a single deposit or billpay), may be a multi-use code (for multiple deposits/billpays), may be time-limited (e.g., may expire after a certain amount of time), etc.

In step 225, the customer may provide the deposit/billpay amount and the code to the merchant point of transaction device (e.g., a point of sale, or POS, device) by, for example, scanning the machine-readable code, communicating the NFC code, entering or speaking the alphanumeric code, etc., and in step 230, merchant point of transaction may receive the code. The merchant may further enter the amount received from the customer.

In step 235, the merchant point of transaction may contact the issuer's merchant acquirer services to request a deposit/billpay. The merchant point of transaction may provide the amount of the received from the customer. The merchant may further provide the code, or it may extract the relevant information from the code (e.g., a session identifier, account identifier(s), payee identifier(s), etc.).

In steps 240 and 245, the issuer's merchant acquirer services may send the deposit/billpay request including the code (or extracted information from the code), and the amount received by the merchant to the issuer's merchant services via a payment network or a direct network connection.

In step 250, the issuer's merchant services send the deposit/billpay request to the issuer's deposit/billpay service with the code or information extracted from the code and the amount received by the merchant. The deposit/billpay may be processed in real-time, in batch, etc.

For example, the code may identify the customer, the deposit account, the dollar amount, etc. In one embodiment, the funds may be deposited to a plurality of accounts, each of which may receive the same or different amounts. In one embodiment, the code may also identify a payee for a bill pay instruction.

In step 255, the deposit/billpay service may process the deposit or billpay. For example, it may deposit the amount received to the account(s) identified in the code, may execute a billpay to the payee(s) identified in the code or the specified amounts, etc.

In one embodiment, if the deposit amount submitted by the customer and the deposit amount received by the merchant are not the same, the issuer deposit service may communicate an alert to the customer mobile electronic device and/or the merchant.

In another embodiment, if the amount received is greater than the amount of the billpay, the balance may be deposited to a default account.

In steps 260 and 265, the issuer's merchant services may return a deposit/billpay confirmation to the merchant point of transaction device via the payment network, and in step 270, the merchant point of transaction may print a receipt communicate a receipt to the customer's mobile electronic device. The receipt may include, for example, a total amount of deposits and/or payments, specific deposit and/or payment details, etc.

In step 275, the customer may view the transaction and account balances using the mobile application or browser. For example, specific details on the deposits and/or payments may be available through the financial institution's application and/or website.

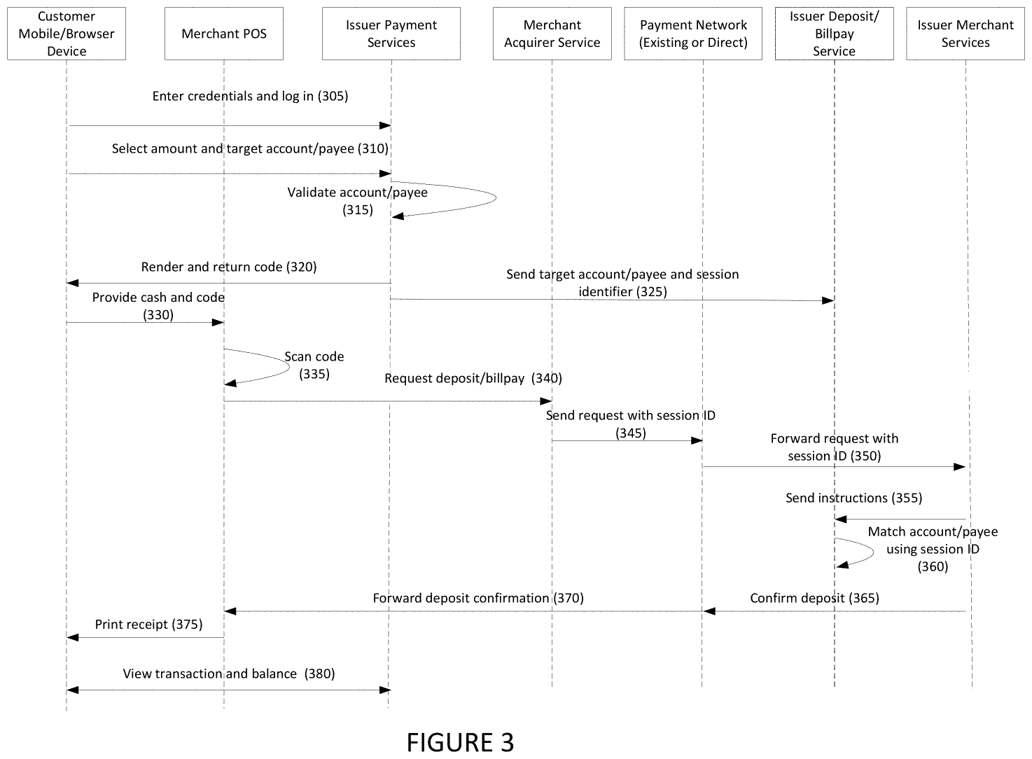

Referring to FIG. 3, a method for accepting cash deposits or billpays at merchant point of transaction devices is provided according to another embodiment. In step 305, a customer may login to a mobile electronic device by entering his or her credentials, and in step 310, the customer may select a deposit/billpay amount and one or more target account (e.g., a DDA, a checking account, etc.), one or more payee, a combination of the two (e.g., deposit $150 to savings, $50 to checking, pay wireless provider $100). These steps may be similar to steps 205 and 210, above.

In step 315, the issuer payment services may validate the deposit account(s) and/or the payee(s), and in step 320, the issuer payment services may render and return a machine-readable code (e.g., a QR code, a bar code, etc.), a NFC code, a token, an alphanumeric code, etc. to the mobile electronic device. These steps may be similar to steps 315 and 320, above.

In one embodiment, the code may be a session identifier that identifies a unique session with the customer electronic device.

In step 325, the issuer payment services or the customer electronic device may communicate the session identifier, the deposit account(s) and/or payee(s), and the amount to the issuer deposit/billpay services, the issuer merchant services, or any other suitable service. This may be communicated without using a payment network.

In step 330, the customer may provide the deposit/billpay amount and the code to the merchant point of transaction device (e.g., a point of sale, or POS, device) by, for example, scanning the machine-readable code, communicating the NFC code, entering or speaking the alphanumeric code, etc., and in step 335, merchant point of transaction may receive the code. The merchant may further enter the amount of the deposit/billpay. These steps may be similar to steps 225 and 230, above.

In step 340, the merchant point of transaction may contact the issuer's merchant acquirer services to request a deposit/billpay. The merchant point of transaction may provide the amount of the received from the customer. The merchant may further provide the code, or it may extract the relevant information from the code (e.g., the session identifier).

In steps 345 and 350, the issuer's merchant acquirer services may send the deposit/billpay request including the code (or extracted information from the code), and the amount received by the merchant to the issuer's merchant services via a payment network or a direct network connection. These steps may be similar to steps 240 and 245, above.

In step 355, the issuer's merchant services send the deposit/billpay request to the issuer's deposit/billpay service with the code or information extracted from the code and the amount received by the merchant. The deposit/billpay may be processed in real-time, in batch, etc.

In step 360, the deposit/billpay service, or the issuer merchant services, may match the session identifier to the session identifier received from the issuer payment services to identify the deposit account(s) and/or the payee(s), and the amount(s) of the deposits or payments.

In another embodiment, the issuer deposit service may use timing of the deposit to match the deposit with the customer and account. An example such timing is provided in U.S. Provisional Patent Application Ser. No. 62/703,164, the disclosure of which is hereby incorporated, by reference, in its entirety.

The deposit/billpay service may then execute the deposit(s) and/or billpay(s).

In one embodiment, if the deposit amount submitted by the customer and the deposit amount received by the merchant are not the same, the issuer deposit service may communicate an alert to the customer mobile electronic device and/or the merchant.

In another embodiment, if the amount received is greater than the amount of the billpay, the balance may be deposited to a default account.

In steps 365 and 370, the issuer's merchant services may return a deposit/billpay confirmation to the merchant point of transaction device via the payment network, and in step 375, the merchant point of transaction may print or communicate a receipt to the customer's mobile electronic device. These steps may be similar to steps 260, 265, and 270, above.

In step 380, the customer may view the transaction and account balances using the mobile application or browser. This may be similar to step 275, above.

Although several embodiments have been disclosed, it should be recognized that these embodiments are not exclusive to each other, and certain elements or features from one embodiment may be used with another.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for accepting cash deposits at merchant point of transaction devices, comprising:
at an information processing apparatus for a financial institution:
receiving, from a customer mobile device, a mobile deposit request comprising a deposit account identifier for a deposit;
generating a deposit code for the mobile deposit request;
communicating the deposit code to the customer mobile device;
receiving, from a merchant point of transaction device, a deposit request comprising the deposit code and a received deposit amount;
identifying, from the deposit code, the deposit account identifier; and
depositing the received deposit amount to a deposit account associated with the deposit account identifier.

2. The method of claim 1, wherein the mobile deposit request further comprises a submitted deposit amount.

3. The method of claim 2, further comprising:
sending a notification to the customer mobile device in response to the submitted deposit amount being different from the received deposit amount.

4. The method of claim 1, wherein the deposit code comprises a one-time code.

5. The method of claim 1, wherein the deposit code comprises a machine-readable code.

6. The method of claim 1, wherein the deposit request is received over a payment network.

7. The method of claim 1, further comprising:
sending a deposit confirmation to the merchant point of transaction device.

8. The method of claim 1, further comprising:
sending a deposit confirmation to the customer electronic device.

9. A method for accepting billpays at merchant point of transaction devices, comprising:
at an information processing apparatus for a financial institution:
receiving, from a customer mobile device, a mobile billpay request comprising a billpay payee identifier and a submitted billpay amount;
generating a billpay code for the mobile billpay request;
communicating the billpay code to the customer mobile device;
receiving, from a merchant point of transaction device, a billpay request comprising the billpay code and a received billpay amount;
identifying, from the billpay code, the billpay payee identifier; and
executing a billpay to the billpay payee for the billpay amount.

10. The method of claim 9, further comprising:
sending a notification to the customer mobile device in response to the submitted billpay amount being different from the received billpay amount.

11. The method of claim 9, wherein the billpay code comprises a one-time code.

12. The method of claim 9, wherein the billpay code comprises a machine-readable code.

13. The method of claim 9, wherein the billpay request is received over a payment network.

14. The method of claim 9, further comprising:
sending a billpay confirmation to the merchant point of transaction device.

15. The method of claim 9, further comprising:
sending a billpay confirmation to the customer electronic device.

16. A method for accepting cash deposits at merchant point of transaction devices, comprising:
at an information processing apparatus for a financial institution:
receiving, from a customer mobile device, a mobile deposit request comprising a deposit account identifier for a deposit or a mobile billpay request comprising a billpay payee identifier and a billpay amount;
communicating the deposit account identifier or the billpay payee identifier and the billpay amount and a session identifier for the session with the customer mobile device to a deposit or billpay service;
generating a code for the mobile deposit request or the mobile billpay request, wherein the code comprises the session identifier;
communicating the code to the customer mobile device;
receiving, from a merchant point of transaction device, a deposit or billpay request comprising the code and a received amount;
identifying, from the code, the session identifier;
identifying the deposit account or billpay payee and billpay amount matching the session identifier; and
depositing the received amount to the deposit account or executing a billpay to the billpay payee for the billpay amount.

17. The method of claim 16, wherein the mobile deposit request further comprises a submitted deposit amount.

18. The method of claim 16, wherein the deposit account identifier or the billpay payee identifier and the billpay amount and the session identifier is communicated to the deposit or billpay service over a private network.

19. The method of claim 16, wherein the deposit request or the billpay request is received over a payment network.

20. The method of claim 16, further comprising:
sending a deposit confirmation or a billpay confirmation to the customer electronic device.
